(19) United States
(12) Patent Application Publication
(10) Pub. No.: US 2014/0094240 A1
(43) Pub. Date: Apr. 3, 2014

(54) TWO DIMENSIONAL POKER GAME AND PROCESS FOR PLAYING A TWO DIMENSIONAL POKER GAME

(71) Applicants: STEPHEN ROY WEBSTER, CALABASAS, CA (US); BILLY DICKSON, CALABASAS, CA (US)

(72) Inventors: STEPHEN ROY WEBSTER, CALABASAS, CA (US); BILLY DICKSON, CALABASAS, CA (US)

(21) Appl. No.: 14/035,381

(22) Filed: Sep. 24, 2013

Related U.S. Application Data
(60) Provisional application No. 61/709,289, filed on Oct. 3, 2012.

(51) Int. Cl. G07F 17/32

(52) U.S. Cl. CPC G07F 17/3293
USPC 463/13

(57) ABSTRACT

Some embodiments include a two-dimensional poker game which includes a game board having a number of spaces for receiving game cards from one or more players. Game cards are placed on the game board such that they correspond in value or in suit with one or more previously placed game cards. Upon placing between one and five game cards on the game board to form a poker hand, a player receives a score. Scores established for particular poker hands may be modified if cards placed by the player cover a specially designated game board space. After each turn, a player adds the score earned for the current placed poker hand to any score from previous turns. At the end of the game, the value of any game cards remaining in a player's possession are deducted from the players cumulative score.

This application claims benefit to U.S. Provisional Patent Application 61/709,289, entitled “Two-Dimensional Poker Game,” filed Oct. 3, 2012. The U.S. Provisional Patent Application 61/709,289 is incorporated herein by reference.

### BACKGROUND

The embodiments herein relate generally to amusing games involving a number of game pieces arranged in groupings to score points, and in particular game apparatuses and processes for playing any of a number of variants of the card game known as poker.

A typical poker game requires a player to collect a plurality of cards each having a suit and a value into a grouping or “hand” having a collective value. Such hands include pairs, three-of-a kind, four-of-a kind, straight, full house and flush.

Generally, a player attempts to assemble a hand of a high value and propose a bet in accordance with the value of the grouping. However, much more sophisticated strategies are possible which sometimes include proposing a relatively high bet even if the player holds a relatively low-value hand. In this way it sometimes becomes possible to intimidate other players into forfeiting or folding their hand.

Most known poker games do not require either individual cards or hands to comply with any rules of spacial arrangement and do not require any particular correspondence between a card or hand of one player and a card or hand of another player. Generally accepted spatial arrangements are commonly used by poker players everywhere. However, these commonly used arrangements have become norms for playing poker. Thus, there have been little to no variations or adaptations to the game of poker.

Thus, what is needed is a way to allow variations in the play of poker.

### BRIEF SUMMARY

Some embodiments of the invention provide a novel process for playing a two-dimensional poker game. The process in some embodiments comprises (i) distributing a plurality of game cards to each of one or more players and (ii) placing a set of game cards, from one of the pluralities of game cards distributed to the players, on a game board comprising a plurality of adjacent spaces. In some embodiments, each player is distributed seven game cards. In some embodiments, the set of game cards placed on the game board comprises at least one game card and no more than five game cards. In some embodiments, game cards are positioned such that any game cards placed on the board form a poker hand on the game board and at least one of the placed game cards corresponds in suit or in value with one or more of any previously-placed, adjacent game cards. In some embodiments, previously-placed game cards are capable of contributing to the hand of currently placed cards.

In some embodiments, the process for playing the two-dimensional poker game is implemented as a software application that runs on a computing device associated with a poker player playing the two-dimensional poker game. In some embodiments, the software application includes sets of instructions for communicating with a set of computing devices associated with a set of other poker players in competition against the poker player playing the poker game.

Some embodiments of the invention provide a novel game board arranging a set of poker cards during a game of poker. In some embodiments, the game board comprises a plurality of adjacent spaces for placing poker cards in a particular arrangement. In some embodiments, the game board comprises a square grid. In some of these embodiments, the game board comprises a plurality of square grids to accommodate a plurality of simultaneously played poker games. In some embodiments, the game board comprises a hexagonal game grid.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic view of an example square grid board in some embodiments.

FIG. 2 conceptually illustrates a detail schematic view of a “one pair” exemplification on an example square grid board in some embodiments.

FIG. 3 conceptually illustrates a detail schematic view of a “two pairs” exemplification on an example square grid board in some embodiments.

FIG. 4 conceptually illustrates a detail schematic view of a “three of a kind” exemplification on an example square grid board in some embodiments.

FIG. 5 conceptually illustrates a detail schematic view of a “straight” exemplification on example square grid board in some embodiments.

FIG. 6 conceptually illustrates a detail schematic view of a “flush” exemplification on an example square grid board in some embodiments.

FIG. 7 conceptually illustrates a detail schematic view of a “full house” exemplification on an example square grid board in some embodiments.

FIG. 8 conceptually illustrates a detail schematic view of a “three pairs” exemplification on an example square grid board in some embodiments.

FIG. 9 conceptually illustrates a detail schematic view of a “four of a kind” exemplification on an example square grid board in some embodiments.

FIG. 10 conceptually illustrates a detail schematic view of a “straight flush” exemplification on an example square grid board in some embodiments.

FIG. 11 conceptually illustrates a detail schematic view of a “four pairs” exemplification on an example square grid board in some embodiments.

FIG. 12 conceptually illustrates a detail schematic view of a “royal flush” exemplification on an example square grid board in some embodiments.

FIG. 13 conceptually illustrates a detail schematic view of a “five pairs” exemplification on an example square grid board in some embodiments.

FIG. 14 conceptually illustrates a detail schematic view of a “legal move” exemplification on an example square grid board in some embodiments.

FIG. 15 conceptually illustrates a detail schematic view of an “illegal move” exemplification on an example square grid board in some embodiments.

FIG. 16 conceptually illustrates a detail schematic view of a “three pair” exemplification on an example square grid board in some embodiments.

FIG. 17 conceptually illustrates a detail schematic view of a “straight flush” exemplification on an example square grid board in some embodiments.

FIG. 18 conceptually illustrates a schematic view of an example hexagonal grid board in some embodiments.

FIG. 19 conceptually illustrates a detail schematic view of a “one pair” exemplification on an example hexagonal grid board in some embodiments.

FIG. 20 conceptually illustrates a detail schematic view of a “two pair” exemplification on an example hexagonal grid board in some embodiments.

FIG. 21 conceptually illustrates a detail schematic view of a “three of a kind” exemplification on an example hexagonal grid board in some embodiments.

FIG. 22 conceptually illustrates a detail schematic view of a “three of a kind” exemplification on an example hexagonal grid board in some embodiments.

FIG. 23 conceptually illustrates a detail schematic view of a “flush” exemplification on an example hexagonal grid board in some embodiments.

FIG. 24 conceptually illustrates a detail schematic view of a “full house” exemplification on an example hexagonal grid board in some embodiments.

FIG. 25 conceptually illustrates a detail schematic view of a “three of a kind” exemplification on an example hexagonal grid board in some embodiments.

FIG. 26 conceptually illustrates a detail schematic view of a “four of a kind” exemplification on an example hexagonal grid board in some embodiments.

FIG. 27 conceptually illustrates a detail schematic view of a “straight flush” exemplification on an example hexagonal grid board in some embodiments.

FIG. 28 conceptually illustrates a detail schematic view of a “four pairs” exemplification on an example hexagonal grid board in some embodiments.

FIG. 29 conceptually illustrates a detail schematic view of a “royal flush” exemplification on an example hexagonal grid board in some embodiments.

FIG. 30 conceptually illustrates a detail schematic view of a “five pairs” exemplification on an example hexagonal grid board in some embodiments.

FIG. 31 conceptually illustrates a detail schematic view of a “legal move” exemplification on an example hexagonal grid board in some embodiments.

FIG. 32 conceptually illustrates a detail schematic view of an “illegal move” exemplification on an example hexagonal grid board in some embodiments.

FIG. 33 conceptually illustrates a detail schematic view of a “five pairs” exemplification on an example hexagonal grid board in some embodiments.

FIG. 34 conceptually illustrates a detail schematic view of an “illegal move” exemplification on an example hexagonal grid board in some embodiments.

FIG. 35 conceptually illustrates a detail schematic view of a “five pairs” exemplification on an example hexagonal grid board in some embodiments.

FIG. 36 conceptually illustrates a detail schematic view of a “five pairs” exemplification on an example hexagonal grid board in some embodiments.

FIG. 37 conceptually conceptually illustrates an electronic system with which some embodiments of the invention are implemented.

### DETAILED DESCRIPTION

In the following detailed description, several examples and embodiments of the invention are described. However, it will be clear to a person skilled in the art that the invention is not limited to the embodiments set forth and can be adapted for any of several other uses.

Some embodiments of the invention provide a novel process for playing a two-dimensional poker game. The process in some embodiments comprises (i) distributing a plurality of game cards to each of one or more players and (ii) placing a set of game cards, from one of the pluralities of game cards distributed to the players, on a game board comprising a plurality of adjacent spaces. In some embodiments, each player is distributed seven game cards. In some embodiments, the set of game cards placed on the game board comprises at least one game card and no more than five game cards. In some embodiments, game cards are positioned such that any game cards placed on the board form a poker hand on the game board and at least one of the placed game cards corresponds in suit or in value with one or more of any previously-placed, adjacent game cards. In some embodiments, previously-placed game cards are capable of contributing to the hand of currently placed cards.

In some embodiments, the process for playing the two-dimensional poker game is implemented as a software application that runs on a computing device associated with a poker player playing the two-dimensional poker game. In some embodiments, the software application includes sets of instructions for communicating with a set of computing devices associated with a set of other poker players in competition against the poker player playing the poker game.

Some embodiments of the invention provide a novel game board arranging a set of poker cards during a game of poker. In some embodiments, the game board comprises a plurality of adjacent spaces for placing poker cards in a particular arrangement. In some embodiments, the game board comprises a square grid. In some of these embodiments, the game board comprises a plurality of square grids to accommodate a plurality of simultaneously played poker games. In some embodiments, the game board comprises a hexagonal game grid.

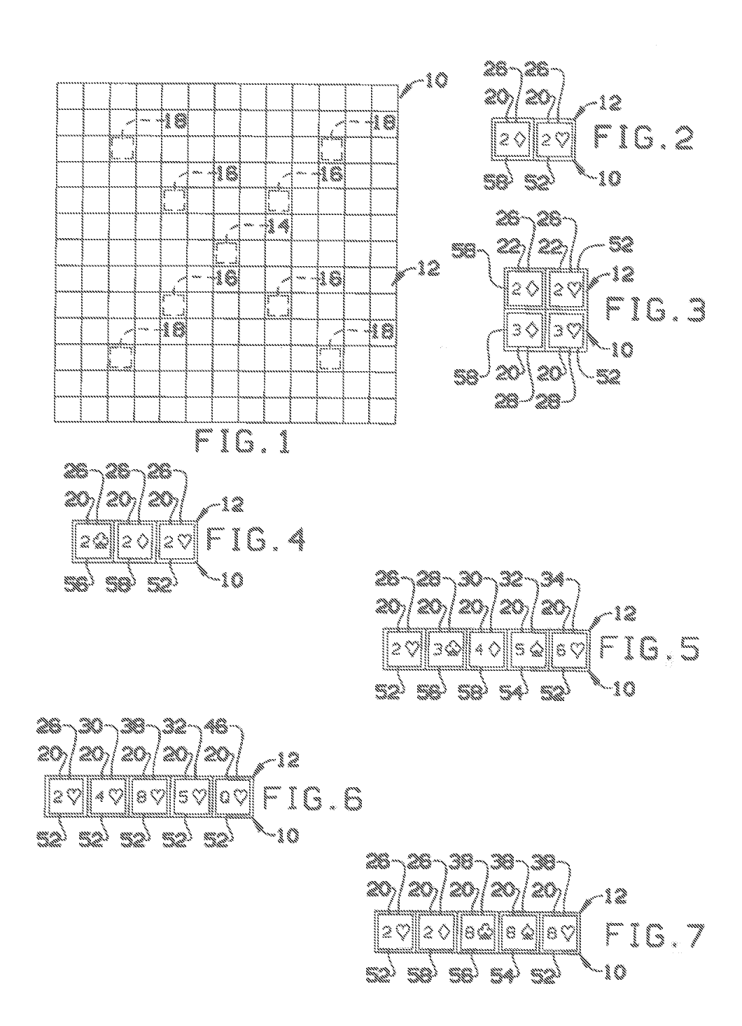

FIG. 1 conceptually illustrates a schematic view of an example square grid board in some embodiments. As shown in this figure, a square grid board 10 provides a number of spaces 12 for the placement of the current-turn played cards 20. The board 10 shown in this figure includes 13 rows and 13 columns for a total of 169 spaces 12. However, in some embodiments, other configurations of board 10 include a different number of rows, a different number of columns, or both a different number of rows and a different number of columns. In some embodiments, the board 10 is arranged with an equal number of rows and columns. Whatever the arrangement, the board 10 arrangement can be determined based on the number of playable spaces 12 desired. In some embodiments, one or more of the spaces 12 have particular significance for game play. For example, space 14 is the center space, spaces 16 are double score spaces and spaces 18 are triple score spaces. If a player plays a hand which covers a double score space 16, the score of the hand played is doubled. If a player plays a hand which covers a triple score space 18, the score of the hand played is tripled. Center space 14 may be treated as a double score space 16.

In some embodiments, a physical hard copy game board 10 is a tangible item constructed of any suitable durable material. Such materials may include but are not limited to cardboard, plastic, wood, or stone. In some embodiments, the game board 10 is constructed of a pliable material that can be rolled and folded. For example, the game board may be constructed of felt to allow a player to role up the game board for easy transport.

Current-turn played cards 20 and previous-turn played cards 22 resemble typical playing cards from a standard 52-card deck and, as such, comprise four suits including Clubs, Diamonds, Hearts and Spades each having values 2, 3, 4, 5, 6, 7, 8, 9, 10, Jack, Queen, King and Ace. While cards 20 and 22 may include a mechanism for temporarily securing them to board 10, they are otherwise generally distinct and separable from board 10. In some embodiments, two or more joker cards may also be included.

In some embodiments that use a physical hard copy game board 10, the cards 20 and 22 are also constructed of any suitable durable material including but not limited to laminated paper, cardboard, plastic, wood, metal, or stone.

In some embodiments, the square grid game board 10 is displayed on a display screen of a computing device. The computing device is associated with a player. In some embodiments, a server application provides a poker game service and centrally manages operations of a plurality of players who each play on their own computing device. In some embodiments, the computing devices are mobile computing devices that each run an app that connects to the poker game service to play a game of poker. The server application in some embodiments transmits poker game information in response to each request to play in a poker game. The poker game information comprises game board layout data, player information, and dealer information. The app running on a mobile device receives the poker game information and renders a game board interface on a display screen of the mobile computing device. In some embodiments, the displayed game board 10 comprises a set of user-configurable parameters that allow a user to set the appearance of the game board 10 on the user's computing device. The user-configurable parameters include such visible features as color, size, zoom level, orientation, and other such visible display features. In some embodiments, a first poker player user who sets the appearance of the game board 10 during a game of poker does not effect the display parameters of the board 10 that gets displayed on another poker player user's computing device display screen. Thus, a first player can set a color scheme of green and white, while a second player sets a color scheme of red and black. In this way, players of the same game of poker can alter the appearance of the game board with respect to their own display screen without altering the appearance of the game board with respect to other players' display screens.

There are a variety of methods of playing the present two-dimensional poker game and at least four example rule sets are disclosed herein.

During play, a player uses the cards distributed to him or her by a dealer to attempt to make the best score available. To begin, a player designated as a ‘Dealer’ deals 7 cards to each player. The first non-dealer player to play is to the left of the dealer. The first player places one or more cards such that they cover center space 14 and represent a standard, legitimate poker hand extending either horizontally or vertically on board 10. Cards already on the board can be used as part of the hand played. In one example method of play according to a first rule set, cards currently played must match, either in suit or in value, one or more cards already placed on board 10 in one or more of spaces 12.

In some embodiments in which the poker game is played via computing devices, the dealer can be a logical computing unit or module of the server application. Also, in some embodiments, the players using computing devices to play in the poker game are organized logically within the game board interface, such that a display device showing the game board interface will also show a representation of each player in a position around the game board. The representation of the player can be any graphical representation, such as an icon, an avatar, an image, a textual name element, etc. In some embodiments, the player representation that is shown on a computer display screen to be positioned to the left of a deal representation is the first player to play. Using the computing device, the player uses one or more graphical tools provided in the game board interface to place cards on the center space, as is similarly performed on a physically embodied game board.

After placing a configuration of cards on board 10 during a turn, a player picks up from the remaining pack as many cards as he or she played, until there are no more cards.

When a player cannot make a legal move with the cards in his or her possession, the player discards any card determined to be undesirable to a discard pile. After discarding one or more cards, the player does not play until their next turn. Any player, on their turn, may use the top card on the discard pile to assist their hand.

During the last round, when a player plays his or her last card he or she announces “LAST ROUND”, alerting all other players to the fact that any cards in their possession will score against them. All players play until play reaches the player who announced “LAST ROUND.” If a player does not announce “LAST ROUND” then the LAST ROUND does not begin until any player announces “LAST ROUND.” At the end of the LAST ROUND, scores are tallied and any cards left in a player's possession are deducted from the tallied score. The player designated as “Dealer” in the subsequent game becomes the player to the left of the previous Dealer.

In some embodiments, when the poker game is played on computing devices, the players each use a set of tools available in a game interface displayed on the display screen of their computing device, to perform operations during the game. In some embodiments, the users have tools for performing private operations that other players cannot see on their display screens. For example, without revealing any cards, the player may wish to organize, by suit or value, any cards in his hand that are not publicly shown on the game board, so the player may use a private tool that allows the cards to be organized. In addition to the private tools, each player has a set of tools for performing public operations. For example, the player may wish to raise the ante and would therefore use a public tool to announce the amount by which the player intends to raise the ante.

In addition to the tools available in the game interface of each player, other features available in the game interface may allow the player to perform operations in relation to the poker game that is ongoing, or in some cases, perform other operations that may only be tangentially related to the ongoing poker game. In some embodiments, one such feature is a plug-in to an account management interface that allows the player to view and coordinate resources (e.g., participation fees, fun tokens, and other items for participating, etc.) for playing in a game of poker. For example, the player may be involved in a high stakes poker game that requires the player to verify that he has a particular level of resources to continue playing the game. In some embodiments, the account management interface connects to external resource management accounts and allows the user to temporarily access the external accounts without interrupting the game.

In some embodiments, scoring for the poker game depends on the scoring configuration implemented for the hand of cards a player has in a game. FIGS. 2-17 depict several scoring configurations of cards.

FIG. 2 conceptually illustrates a detail schematic view of a “one pair” exemplification on an example square grid board in some embodiments. The example in this figure depicts a single play “one pair” exemplification placed on square grid board 10. In some embodiments, this play may be scored as five points. However, while “one pair” may be the lowest-scoring play, the actual point value may vary.

FIG. 3 conceptually illustrates a detail schematic view of a “two pairs” exemplification on an example square grid board in some embodiments. The example in this figure depicts the “two pairs” exemplification on square grid board 10 wherein cards 22 were placed by one payer and cards 20 were placed by a subsequent player. According to a first embodiment of method of play, cards 20 must match cards 22. In the example shown, cards 22 are of suits Diamonds and Hearts and therefore, cards 20 are also of suits Diamonds and Hearts and have been placed adjacent to the suits they match on board 10. In some embodiments, this configuration of “two pairs” may be scored as double (10 points) the “one pair” value depicted in FIG. 2.

FIG. 4 conceptually illustrates a detail schematic view of a “three of a kind” exemplification on an example square grid board in some embodiments. The example in this figure depicts a single play “three of a kind” exemplification placed on square grid board 10. While the actual point value may vary, in some embodiments, this play may be scored as fifteen points.

FIG. 5 conceptually illustrates a detail schematic view of a “straight” exemplification on example square grid board in some embodiments. The example in this figure depicts a single play “straight” exemplification placed on square grid board 10. While the actual point value may vary, in some embodiments, this play may be scored as twenty points.

FIG. 6 conceptually illustrates a detail schematic view of a “flush” exemplification on an example square grid board in some embodiments. The example in this figure depicts a single play “flush” exemplification placed on square grid board 10. While the actual point value may vary, in some embodiments, this play may be scored as twenty points.

FIG. 7 conceptually illustrates a detail schematic view of a “full house” exemplification on an example square grid board in some embodiments. The example in this figure depicts a single play “full house” exemplification placed on square grid board 10. While the actual point value may vary, in some embodiments, this play may be scored as twenty-five points.

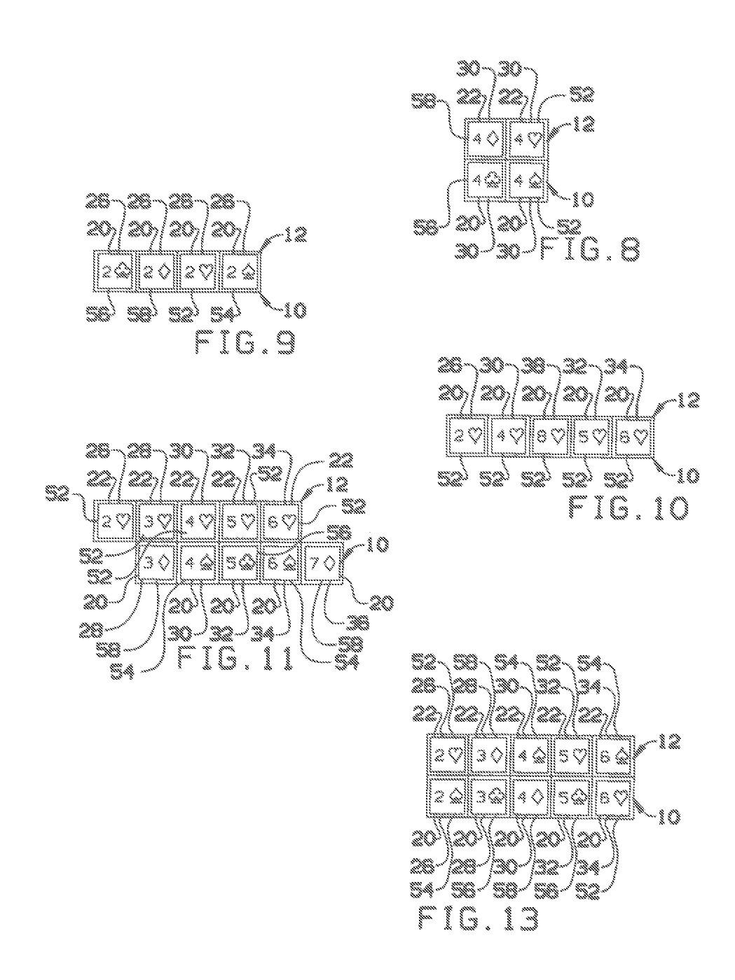

FIG. 8 conceptually illustrates a detail schematic view of a “three pairs” exemplification on an example square grid board in some embodiments. The example in this figure depicts a “three pairs” exemplification placed on square grid board 10 wherein cards 22 were placed by one payer and cards 20 were placed by a subsequent player. According to a first embodiment of method of play, cards 20 must match cards 22. In the example shown, cards 22 have value 4 and therefore, cards 20 also have value 4 and have been placed adjacent to the cards they match on board 10. While the actual point value may vary, in some embodiments, this play may be scored as thirty points.

FIG. 9 conceptually illustrates a detail schematic view of a “four of a kind” exemplification on an example square grid board in some embodiments. The example in this figure depicts a single play “four of a kind” exemplification placed on square grid board 10. While the actual point value may vary, in some embodiments, this play may be scored as thirty-five points.

FIG. 10 conceptually illustrates a detail schematic view of a “straight flush” exemplification on an example square grid board in some embodiments. The example in this figure depicts a single play “straight flush” exemplification placed on square grid board 10. While the actual point value may vary, in some embodiments, this play may be scored as forty points.

FIG. 11 conceptually illustrates a detail schematic view of a “four pairs” exemplification on an example square grid board in some embodiments. The example in this figure depicts a “four pairs” exemplification on square grid board 10 wherein cards 22 were placed by one payer and cards 20 were placed by a subsequent player. According to a first embodiment of method of play, one or more of cards 20 must match one or more of cards 22. In the example shown, some of cards 22 have values 3, 4, 5 & 6 and therefore, some of cards 20 also have values 3, 4, 5 & 6 and have been placed adjacent to the cards they match on board 10. While the actual point value may vary, in some embodiments, this play may be scored as fifty points.

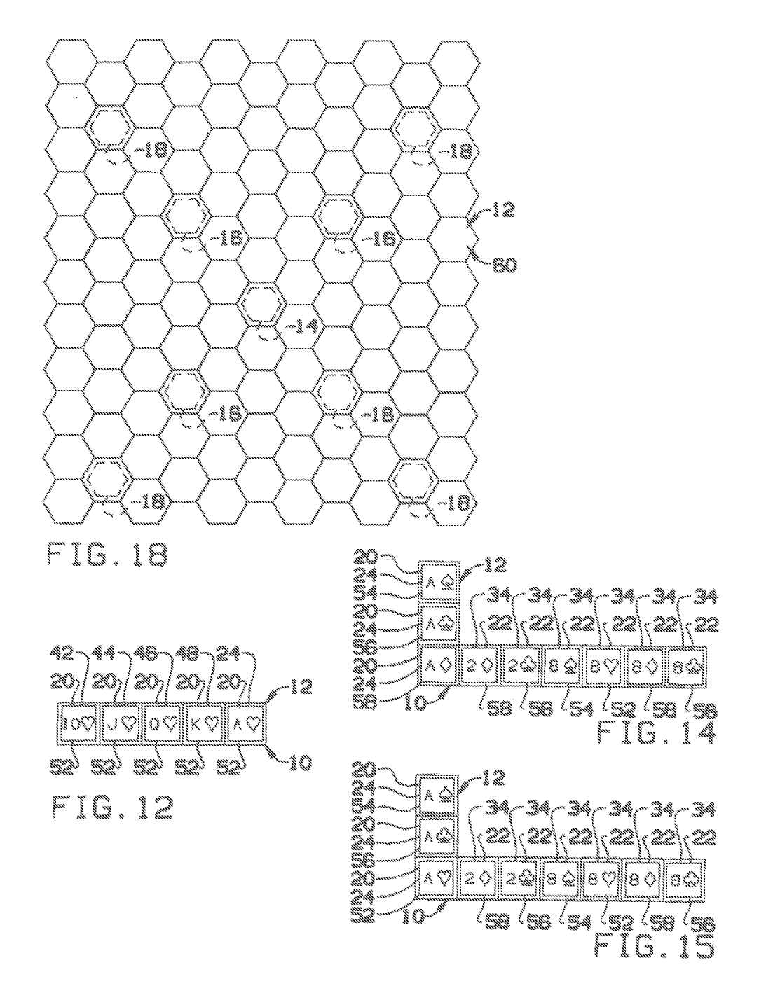

FIG. 12 conceptually illustrates a detail schematic view of a “royal flush” exemplification on an example square grid board in some embodiments. The example in this figure depicts a “royal flush” exemplification on an item 10 exemplary square grid board. While the actual point value may vary, in some embodiments, this play may be scored as fifty points.

FIG. 13 conceptually illustrates a detail schematic view of a “five pairs” exemplification on an example square grid board in some embodiments. The example in this figure depicts a “five pairs” exemplification on square grid board 10 wherein cards 22 were placed by one payer and cards 20 were placed by a subsequent player. According to a first embodiment of method of play, one or more of cards 20 must match one or more of cards 22. In the example shown, cards 22 have values 2, 3, 4, 5 & 6 and therefore, cards 20 also have values 2, 3, 4, 5 & 6 and have been placed adjacent to the cards they match on board 10. While the actual point value may vary, in some embodiments, this play may be scored as sixty points.

FIG. 14 conceptually illustrates a detail schematic view of a “legal move” exemplification on an example square grid board in some embodiments. The example in this figure depicts a “legal move” exemplification on square grid board 10 wherein cards 22 were placed by one payer and cards 20 were placed by a subsequent player. Play started with a first player placing a full house. A subsequent player then placed an 8 to get four of a kind A still subsequent player then placed three Aces for three of a kind. The move is considered legal since the Ace of Diamonds matches the 2 of Diamonds.

FIG. 15 conceptually illustrates a detail schematic view of an “illegal move” exemplification on an example square grid board in some embodiments. The example in this figure depicts an “illegal move” exemplification on square grid board 10 wherein cards 22 were placed by one payer and cards 20 were placed by a subsequent player. Because the Ace of Hearts does not match the 2 of Diamonds and therefore cannot be placed in this position.

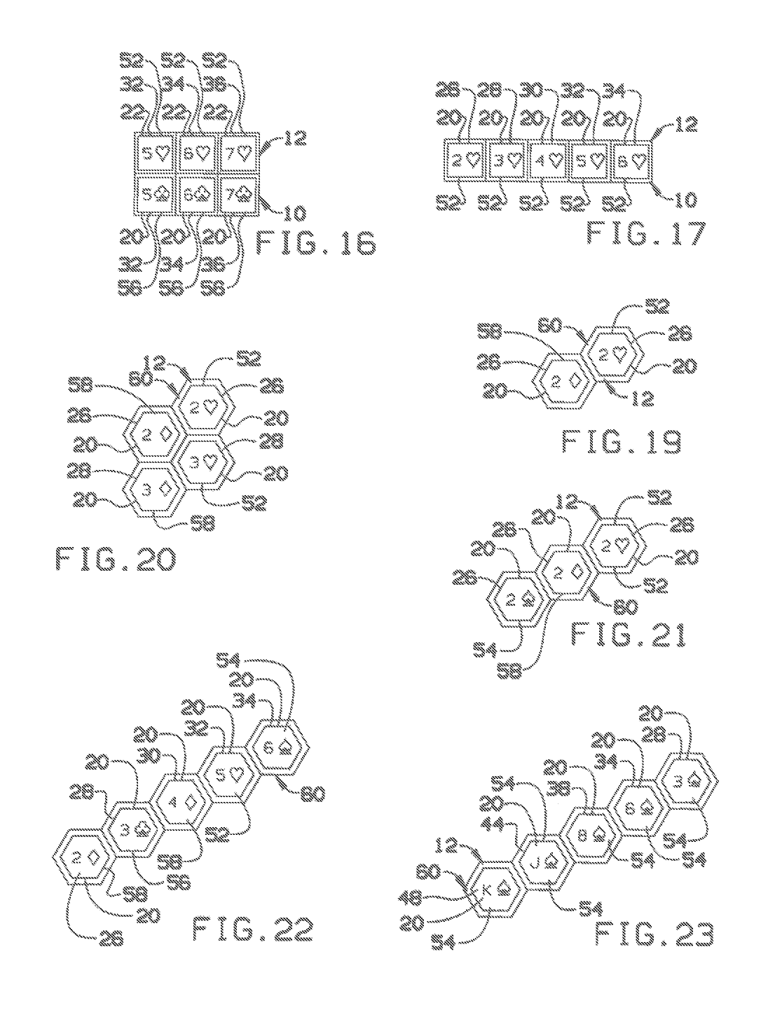

FIG. 16 conceptually illustrates a detail schematic view of a “three pair” exemplification on an example square grid board in some embodiments. The example in this figure depicts an alternative “three pair” exemplification on square grid board 10 wherein cards 22 were placed by one payer and cards 20 were placed by a subsequent player. According to a first embodiment of method of play, one or more of cards 20 must match one or more of cards 22. In the example shown, cards 22 have values 5, 6 & 7 and therefore, cards 20 also have values 5, 6 & 7 and have been placed adjacent to the cards they match on board 10. While the actual point value may vary, in some embodiments, this play may be scored as thirty points.

FIG. 17 conceptually illustrates a detail schematic view of a “straight flush” exemplification on an example square grid board in some embodiments. The example in this figure depicts a “straight flush” exemplification placed on square grid board 10. While the actual point value may vary, in some embodiments, this play may be scored as fifty points.

In some embodiments, a different rule set specifies that all cards played, not just cards played by consecutive players, must be compatible with their neighbor either in suit or in value. In some of these embodiments, “straights” as well as many types of pairs are thus prohibited.

FIG. 18 conceptually illustrates a schematic view of an example hexagonal grid board in some embodiments. The example in this figure depicts a grid game board 60 having spaces 12 of hexagonal configuration for the placement of the current-turn played cards 20 as described above with respect to square grid game board 10. In the embodiment shown, board 60 includes 11 rows and 11 columns for a total of 121 spaces 12. However, other configurations of board 60 which include a different number of spaces 12 may be desirable. As with game board 10, some spaces 12 may have particular significance for game play. For example space 14 is the center space, spaces 16 are double score spaces and spaces 18 are triple score spaces. If a player plays a hand which covers a double score space 16, the score of the hand played is doubled. If a player plays a hand which covers a triple score space 18, the score of the hand played is tripled. Center space 14 is treated as a double score space 16.

In contrast to an embodiment making use of square grid board 10, cards 20 and cards 22 placed adjacent to one another will never be placed in a horizontal configuration. Only vertical and diagonal relationships exist, but no horizontal relationships exist.

FIG. 19 conceptually illustrates a detail schematic view of a “one pair” card hand on an example hexagonal grid board in some embodiments. The example in this figure depicts a “one pair” exemplification placed on an example hexagonal grid board 60. In some embodiments, this play may be scored as five points. However, while “one pair” may be the lowest-scoring play, the actual point value may vary.

FIG. 20 conceptually illustrates a detail schematic view of a diagonal “two pair” card hand on an example hexagonal grid board in some embodiments. The example in this figure depicts a “two pair” exemplification placed on an example hexagonal grid board 60. While the actual point value may vary, in some embodiments, this play may be scored as ten points.

FIG. 21 conceptually illustrates a detail schematic view of a diagonal “three of a kind” card hand on an example hexagonal grid board in some embodiments. The example in this figure depicts a diagonal “three of a kind” exemplification placed on an example hexagonal grid board 60. While the actual point value may vary, in some embodiments, this play may be scored as fifteen points.

FIG. 22 conceptually illustrates a detail schematic view of a “straight” card hand on an example hexagonal grid board in some embodiments. The example in this figure depicts a diagonal “straight” exemplification placed on an example hexagonal grid board 60. While the actual point value may vary, in some embodiments, this play may be scored as twenty points.

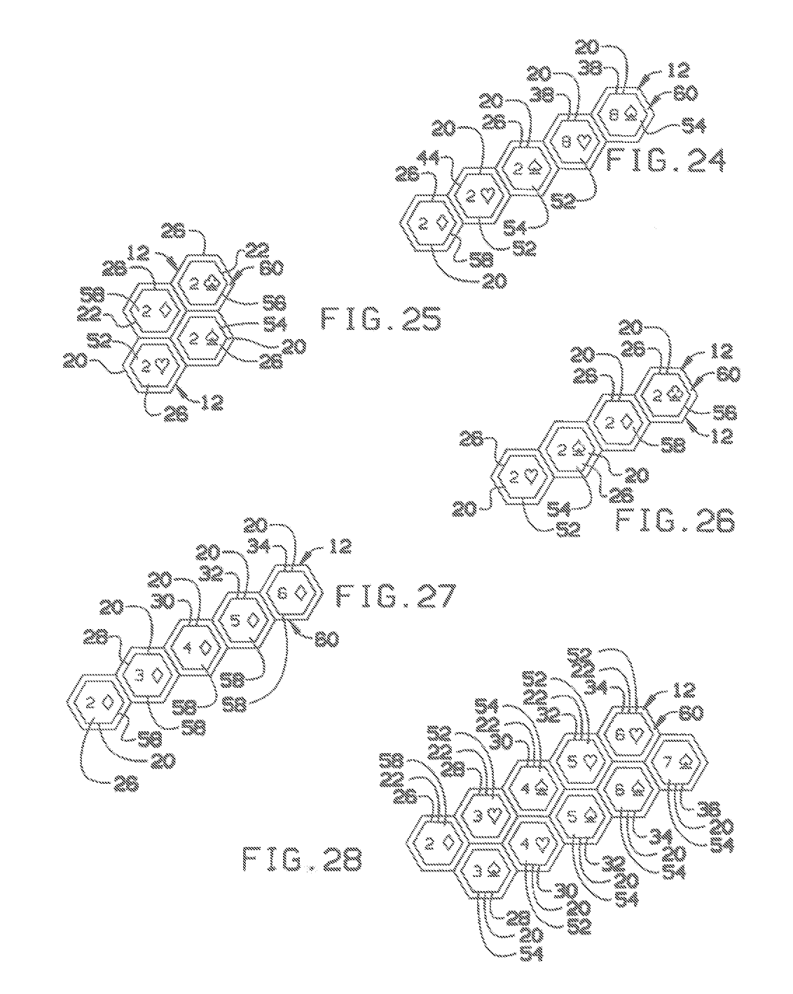

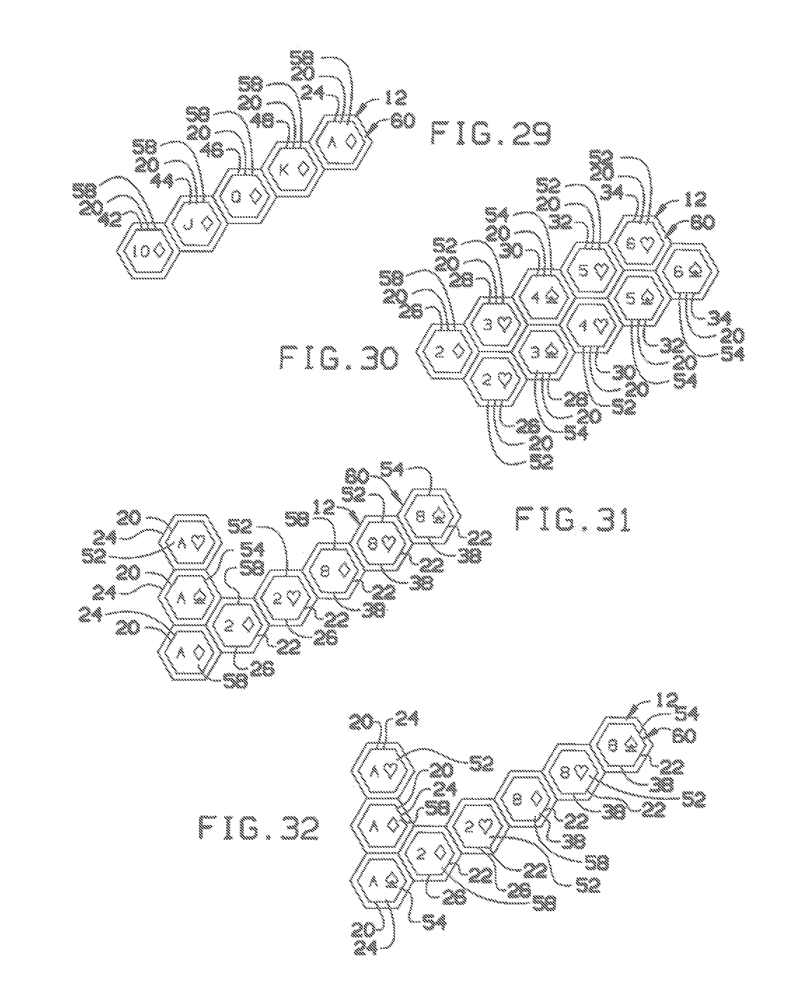

FIG. 23 conceptually illustrates a detail schematic view of a “flush” card hand on an example hexagonal grid board in some embodiments. The example in this figure depicts a diagonal “flush” exemplification placed on an example hexagonal grid board 60. While the actual point value may vary, in some embodiments, this play may be scored as twenty points.

FIG. 24 conceptually illustrates a detail schematic view of a “full house” card hand on an example hexagonal grid board in some embodiments. The example in this figure depicts a diagonal “full house” exemplification placed on an example hexagonal grid board 60. While the actual point value may vary, in some embodiments, this play may be scored as twenty-five points.

FIG. 25 conceptually illustrates a detail schematic view of a “three of a kind” exemplification on an example hexagonal grid board in some embodiments. The example in this figure depicts a “three pairs” hand on an example hexagonal grid board 60 wherein cards 22 were placed by one payer and cards 20 were placed by a subsequent player. According to one embodiment of method of play, cards 20 must match cards 22. In the example shown, cards 22 have value 2 and therefore, cards 20 also have value 2 and have been placed adjacent to the cards they match on board 60. While the actual point value may vary, in some embodiments, this play may be scored as thirty points.

FIG. 26 conceptually illustrates a detail schematic view of a “four of a kind” card hand on an example hexagonal grid board in some embodiments. The example in this figure depicts a “four of a kind” exemplification placed on an example hexagonal grid board 60. While the actual point value may vary, in some embodiments, this play may be scored as thirty-five points.

FIG. 27 conceptually illustrates a detail schematic view of a “straight flush” card hand on an example hexagonal grid board in some embodiments. The example in this figure depicts a “straight flush” exemplification placed on an example hexagonal grid board 60. While the actual point value may vary, in some embodiments, this play may be scored as forty points.

FIG. 28 conceptually illustrates a detail schematic view of a “four pairs” card hand on an example hexagonal grid board in some embodiments. The example in this figure depicts a “four pairs” exemplification on an example hexagonal grid board 60 wherein cards 22 were placed by one payer and cards 20 were placed by a subsequent player. According to one embodiment of method of play, one or more of cards 20 must match one or more of cards 22. In the example shown, some of cards 22 have values 3, 4, 5 & 6 and therefore, some of cards 20 also have values 3, 4, 5 & 6 and have been placed adjacent to the cards they match on board 60. While the actual point value may vary, in some embodiments, this play may be scored as fifty points.

FIG. 29 conceptually illustrates a detail schematic view of a “royal flush” card hand on an example hexagonal grid board in some embodiments. The example in this figure depicts a “royal flush” exemplification on an example hexagonal grid board 60. While the actual point value may vary, in some embodiments, this play may be scored as fifty points.

FIG. 30 conceptually illustrates a detail schematic view of a “five pairs” card hand on an example hexagonal grid board in some embodiments. The example in this figure depicts a “five pairs” exemplification on an example hexagonal grid board 60 wherein cards 22 were placed by one payer and cards 20 were placed by a subsequent player. According to a first embodiment of method of play, one or more of cards 20 must match one or more of cards 22. In the example shown, cards 22 have values 2, 3, 4, 5 & 6 and therefore, cards 20 also have values 2, 3, 4, 5 & 6 and have been placed adjacent to the cards they match on board 60. While the actual point value may vary, in some embodiments, this play may be scored as sixty points.

FIG. 31 conceptually illustrates a detail schematic view of a “legal move” exemplification on an example hexagonal grid board in some embodiments. The example in this figure depicts the “legal move” exemplification on an example hexagonal grid board 60. Note that play started with a full house (2's and 8's). Player 2 plays 3 Aces for 3 of a kind. The move is legal because Ace of Diamonds matches the 2 of Diamonds in suit.

FIG. 32 conceptually illustrates a detail schematic view of an “illegal move” exemplification on an example hexagonal grid board in some embodiments. The example in this figure depicts an “illegal move” exemplification on an example hexagonal grid board 60. Note that neither the Ace of Hearts nor the Ace of Spades matches the 2 of Diamonds and therefore cannot be played in this position. However, the three Aces could be played against the 8 of Hearts which makes this a legal move as depicted in FIG. 36.

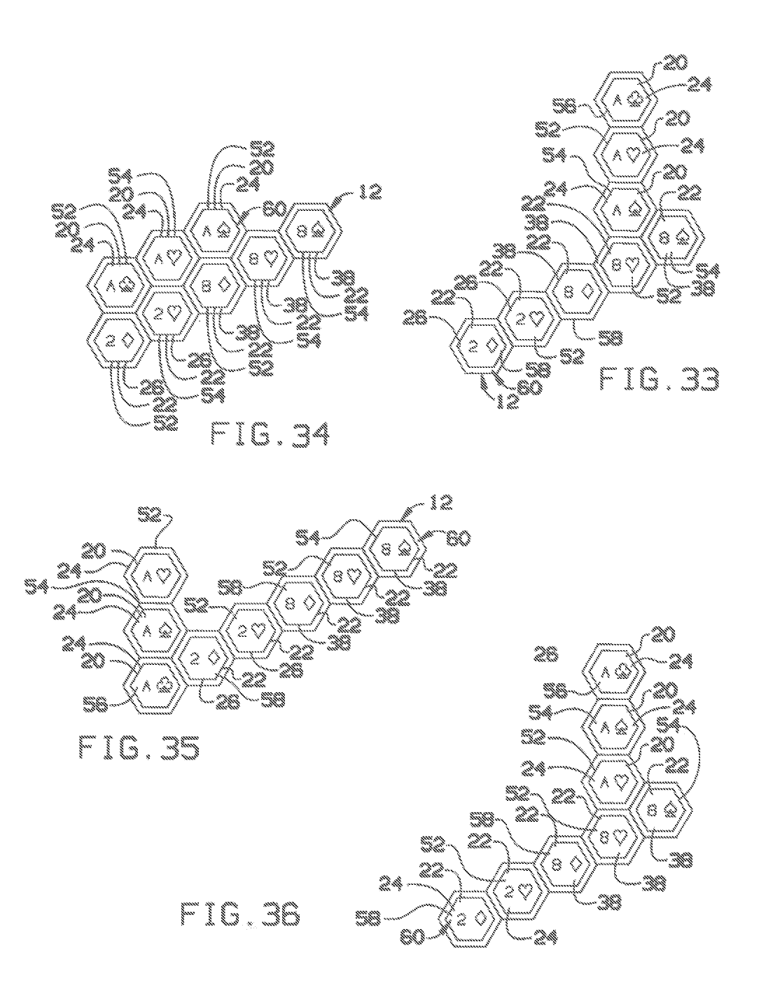

Similarly, the Ace of Spades could be played in the position of the Ace of Hearts, as it borders the 8 of Spades as which makes this a legal move. This is depicted in FIG. 33, which conceptually illustrates a detail schematic view of a “five pairs” exemplification on an example hexagonal grid board in some embodiments.

FIG. 34 conceptually illustrates a detail schematic view of an “illegal move” exemplification on an example hexagonal grid board in some embodiments. The example in this figure depicts an additional “legal move” wherein the Ace of Hearts is adjacent to the 2 of Hearts.

FIG. 35 conceptually illustrates a detail schematic view of a “five pairs” exemplification on an example hexagonal grid board in some embodiments. The example in this figure depicts an additional illegal move wherein the Ace of Spades and the Ace of Clubs which are adjacent to the 2 of Diamonds do not share suit or value with the 2.

Similar to the disclosure above with respect to an embodiment including square grid board 10, according to an alternate rule set embodiment for use with hexagonal grid board 60, all cards played, not just cards played by consecutive players, must be compatible with their neighbor either in suit or in value. In this embodiment, “straights” as well as many types of pairs are thus prohibited.

In some embodiments, the poker game is implemented as one or more software programs that operate on computing devices to allow poker players to play a poker game in an electronic form. As is further described below by reference to an electronic system with which several of the above embodiments are implemented in electronic form, the computer program comprises sets of instructions which when executed by a processing unit of a computing device, perform the operations of the poker game process in any of the forms above. In some embodiments, the program communicates over a network with other instances of the program so that the poker game is accessible by one or more players through the network and can be played against each other or against a computer player with artificial intelligence.

In some embodiments, the components of the game such as the game boards 10 and 60 may be presented to one or more players in electronic form on a display device. In some embodiments, the components are included as graphical user interface (GUI) elements of a GUI game display comprising icons, buttons, control elements, tools, lists, widgets, etc. Cards such as 20 and 22 may be presented to the display as images or icons movable by an input device such as a mouse, or by gestural input of a human finger on a touchscreen display of a computing device.

In electronic form, game rules may be implemented by a computer processor according to the computer readable program code such that a player is prevented from making a play that is not considered legal as provided by the relevant rule set. In some electronic embodiments, the program allows a player to receive notifications of “illegal” plays with respect to the rule set.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

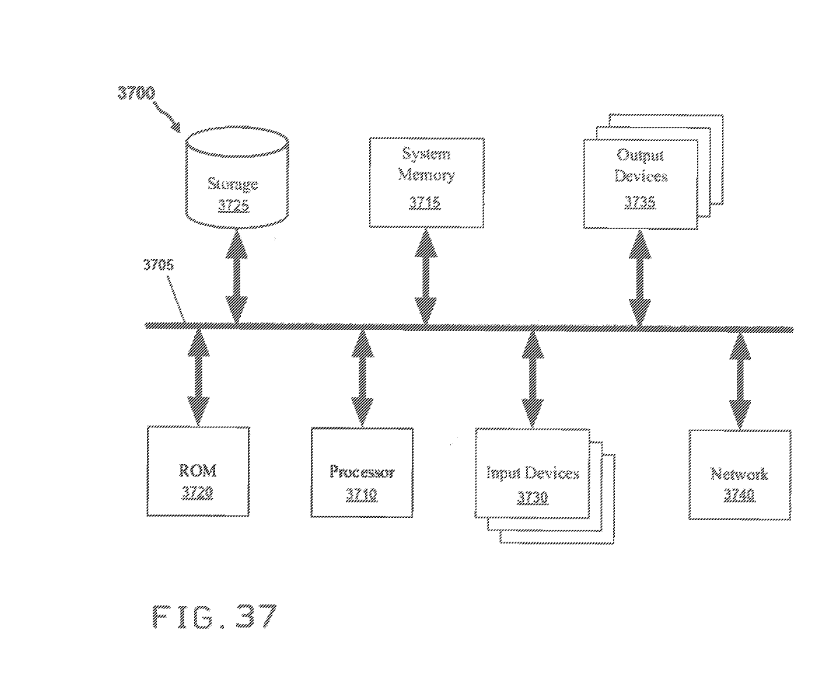

FIG. 37 conceptually conceptually illustrates an electronic system 3700 with which some embodiments of the invention are implemented. The electronic system 3700 may be a computer, phone, PDA, or any other sort of electronic device. Such an electronic system includes various types of computer readable media and interfaces for various other types of computer readable media. Electronic system 3700 includes a bus 3705, processing unit(s) 3710, a system memory 3715, a read-only 3720, a permanent storage device 3725, input devices 3730, output devices 3735, and a network 3740.

The bus 3705 collectively represents all system, peripheral, and chipset buses that communicatively connect the numerous internal devices of the electronic system 3700. For instance, the bus 3705 communicatively connects the processing unit(s) 3710 with the read-only 3720, the system memory 3715, and the permanent storage device 3725.

From these various memory units, the processing unit(s) 3710 retrieves instructions to execute and data to process in order to execute the processes of the invention. The processing unit(s) may be a single processor or a multi-core processor in different embodiments.

The read-only-memory (ROM) 3720 stores static data and instructions that are needed by the processing unit(s) 3710 and other modules of the electronic system. The permanent storage device 3725, on the other hand, is a read-and-write memory device. This device is a non-volatile memory unit that stores instructions and data even when the electronic system 3700 is off. Some embodiments of the invention use a mass-storage device (such as a magnetic or optical disk and its corresponding disk drive) as the permanent storage device 3725.

Other embodiments use a removable storage device (such as a floppy disk or a flash drive) as the permanent storage device 3725. Like the permanent storage device 3725, the system memory 3715 is a read-and-write memory device. However, unlike storage device 3725, the system memory 3715 is a volatile read-and-write memory, such as a random access memory. The system memory 3715 stores some of the instructions and data that the processor needs at runtime. In some embodiments, the invention's processes are stored in the system memory 3715, the permanent storage device 3725, and/or the read-only 3720. For example, the various memory units include instructions for processing appearance alterations of displayable characters in accordance with some embodiments. From these various memory units, the processing unit(s) 3710 retrieves instructions to execute and data to process in order to execute the processes of some embodiments.

The bus 3705 also connects to the input and output devices 3730 and 3735. The input devices enable the user to communicate information and select commands to the electronic system. The input devices 3730 include alphanumeric keyboards and pointing devices (also called “cursor control devices”). The output devices 3735 display images generated by the electronic system 3700. The output devices 3735 include printers and display devices, such as cathode ray tubes (CRT) or liquid crystal displays (LCD). Some embodiments include devices such as a touchscreen that functions as both input and output devices.

Finally, as shown in FIG. 37, bus 3705 also couples electronic system 3700 to a network 3740 through a network adapter (not shown). In this manner, the computer can be a part of a network of computers (such as a local area network (“LAN”), a wide area network (“WAN”), or an Intranet), or a network of networks (such as the Internet). Any or all components of electronic system 3700 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, many of the figures illustrate example poker hands. However, a variety of types of card games can be used on the game board. Thus, one of ordinary skill in the art would understand that the invention is not to be limited by the foregoing illustrative details and examples, but rather is to be defined by the appended claims. Additionally, the dimensions, sizes, layouts, and configurations of game boards are not limited in any way by the foregoing details and examples, but are instead understood to include any dimensions, sizes, layouts, and configurations.

We claim:

1. A non-transitory computer readable medium storing a program which when executed by at least one processing unit of a computing device creates a poker game based on a game board layout, said program comprising sets of instructions for:
receiving a request to play a game of poker from a computing device associated with a user;
creating a game board layout comprising a plurality of playable positions, said game layout based on the received request;
associating the user and a set of other users associated with other computing devices with the newly created poker game;
transmitting, to the computing device of each associated users, game card information for each of seven poker game cards to each of the associated users, said game card information comprising game card suit and game card value; and
transmitting position information for the placement of a set of game cards on the game board for each associated user.

2. The non-transitory computer readable medium of claim 1, wherein the game board layout comprises a square grid playable area comprising a plurality of adjacent card positions.

3. The non-transitory computer readable medium of claim 1, wherein the game board layout comprises a hexagonal grid playable area comprising a plurality of card positions configured in a honeycomb pattern.

4. The non-transitory computer readable medium of claim 1, wherein the set of game cards comprise at least one game card.

5. The non-transitory computer readable medium of claim 1, wherein the set of game cards comprise no more than 5 game cards.

6. The non-transitory computer readable medium of claim 1, wherein the computer program further comprises a set of instructions for scoring a winning hand according to values associated with the positions on which the cards of the winning hand are positioned on the game board layout.

7. The non-transitory computer readable medium of claim 6, wherein each position of a card in the winning hand contributes one point to the score of the winning hand.

8. The non-transitory computer readable medium of claim 6, wherein a center playable position of the game board layout doubles the score of the winning hand if a card of the winning hand is positioned on the center playable position.

9. The non-transitory computer readable medium of claim 6, wherein a set of double-score playable positions of the game board layout each doubles the score of the winning hand if a card of the winning hand is positioned on the double-score playable position.

10. The non-transitory computer readable medium of claim 6, wherein a set of triple-score playable positions of the game board layout each triples the score of the winning hand if a card of the winning hand is positioned on the triple-score playable position.

11. A non-transitory computer readable medium storing a program which when executed by at least one processing unit of a computing device operates a poker game based on a game board layout and a set of poker rules, said program comprising sets of instructions for:
receiving, in each of a set of rounds of play, a plurality of card placements on a plurality of spaces of the game board from a plurality of players of the poker game;
scoring the card placements of each player during each round of play;
receiving a request from a player finalize game play in a final round of play;
tallying the scores of each player over all the rounds of play;
identifying a winning player having the highest tallied score.

12. The non-transitory computer readable medium of claim 11, wherein the set of instructions for receiving the plurality of card placements comprises a set of instructions for receiving a set of card placements from a first player to place the set of cards over a center space of the game board.

13. The non-transitory computer readable medium of claim 11, wherein the set of instructions for scoring the card placements comprises a set of instructions for identifying any adjacent card combinations placed on the game board, wherein an adjacent card combination comprises (i) a first card in the set of cards placed by the first player on the game board and (ii) a second previously placed adjacent card that matches at least one of suit and value of the card.

14. The non-transitory computer readable medium of claim 13, wherein the game board layout comprises a square grid layout, wherein the placement of the first card is at a first game board space and the placement of the second card is at a second game board space that is one of horizontally adjacent to the first game board space and vertically adjacent to the first game board space.

15. The non-transitory computer readable medium of claim 13, wherein the game board layout comprises a hexagonal honeycomb grid layout, wherein the placement of the first card is at a first game board space and the placement of the second card is at a second game board space that is one of diagonally adjacent to the first game board space and vertically adjacent to the first game board space.
